(19) United States
(12) Patent Application Publication
(10) Pub. No.: US 2013/0181617 A1
(43) Pub. Date: Jul. 18, 2013

(54) SYSTEM AND METHOD FOR SPACE VACANCY SENSING USING GAS MONITORING

(71) Applicant: Paul Maddox, Tualatin, OR (US)

(72) Inventor: Paul Maddox, Tualatin, OR (US)

(73) Assignee: LEVITON MANUFACTURING COMPANY, INC., Melville, NY (US)

(21) Appl. No.: 13/351,752

(22) Filed: Jan. 17, 2012

(51) Int. Cl. H05B 37/02; H01H 35/00

(52) U.S. Cl. 315/159; 307/116; 315/362

(57) ABSTRACT

A system and method are disclosed for using gas detection techniques to determine if a room is vacant or occupied, and to activate, dim or deactivate lighting based on a detected occupancy status. The system and method may monitor a concentration of a first gas using a gas sensor such as a CO₂ sensor. The space may also be monitored using second and third sensors, and a vacancy status of the space may be based on the concentration of the first gas and information from the second and third sensors. The second and third sensors can be passive infrared sensors, ultrasonic sensors, gas sensors, microwave sensors, audio sensors, or video sensors. An electrical load associated with the space may be controlled based on the determined occupancy/vacancy status. Other embodiments are described and claimed.

### FIELD OF THE DISCLOSURE

The present disclosure relates generally to occupancy sensors, and more particularly to an improved occupancy sensor that utilizes gas detection to determine whether a room is occupied, and to activate, adjust, or deactivate lighting controls accordingly.

### BACKGROUND OF THE DISCLOSURE

Occupancy sensors are often used to monitor the presence of human occupants in indoor and outdoor spaces. Occupancy sensors can be used to conserve energy by automatically turning off lighting and other electrical loads when the space is unoccupied. Occupancy sensors also perform a convenience function by automatically turning on lighting and other loads when an occupant enters the space.

Numerous sensing technologies have been used with occupancy sensors. One example is passive infrared (PIR) sensing which operates on the principle that the thermal energy of warm objects causes them to emit infrared radiation. Infrared radiation emitted by an object is sensed by a photocell which converts the radiation to electric signals that can be processed to determine if the object is an occupant. Another example of occupancy sensing technology is ultrasonic sensing. In an ultrasound system, the monitored space is flooded with ultrasonic waves that are constantly emitted by an ultrasound driver. An ultrasound sensor detects waves that are reflected by an occupant and/or other objects in the monitored space. By comparing the emitted and reflected waves, an ultrasonic system can determine whether an object is moving. Moving objects are assumed to be occupants. Other occupancy detection technologies can include microwave and acoustic approaches.

Some conventional occupancy sensors use a combination of sensing technologies. One widely used combination is PIR and ultrasound. PIR is generally more accurate for detecting large motion such as a person walking into a room in a path that is directly within the line-of-sight of the occupancy sensor. Ultrasound systems tend to be more sensitive for detecting small motion, such as a person working at a desk, and motion that is hidden from the line-of-sight of the occupancy sensor, such as behind partitions in an office or restroom. Another known combination is PIR combined with audio sensing. PIR sensing is used to detect the motion of an occupant entering a room, then audio sensing is used to detect sounds that indicate continued occupancy.

Despite many years of development and attempts to perfect various sensing technologies and combinations of technologies, occupancy sensors continue to be plagued by false determinations of occupied and unoccupied conditions. Although video surveillance or image detection technologies could be used to enhance reliability of such systems, they have drawbacks, not the least of which includes high cost. They can also raise privacy concerns.

Thus, there remains a need for an improved system and method for monitoring spaces for the presence of human occupants, and for controlling lighting and other electrical loads depending upon the occupancy status of the space.

### SUMMARY OF THE DISCLOSURE

A system and method are disclosed for use gas detection techniques, either alone or in combination with other sensing technologies, to detect human occupancy of a space. In one embodiment, the gas detection would include carbon dioxide (CO₂) detection.

A method is disclosed for determining occupancy/vacancy status of a space. The method can include: monitoring a concentration of a first gas in a space using a first gas sensor; determining a status of the space based on the concentration of the first gas; and controlling an electrical load associated with the space based on the determined status.

A system is disclosed for determining a vacancy status of a space. The system can include a first sensor for sensing a gas concentration of a space, and a second sensor for monitoring the space. A controller may be coupled to the first and second sensors for receiving signals from the first and second sensors and for determining an occupancy status of the space based on said received signals, the controller configured to control an electrical load for the space in response to the determined occupancy status.

A method is disclosed for determining vacancy status of a space, comprising: determining a concentration of a first gas in a space using a first gas sensor; monitoring the space for the presence of an occupant using a second sensor; determining a vacancy status of the space based on the concentration of the first gas and occupant presence information from the second sensor; and controlling a lighting load associated with the space based on the determined vacancy status.

### BRIEF DESCRIPTION OF THE DRAWINGS

By way of example, a specific embodiment of the disclosed device will now be described, with reference to the accompanying drawings, in which:

FIG. 1 is a schematic diagram of an embodiment of the disclosed occupancy detection system;

FIG. 2 is an isometric view of an exemplary ceiling mounted occupancy detection system;

FIG. 3 is an isometric view of an exemplary wall mounted occupancy detection system;

FIG. 4 is a plan view of a monitored space including an embodiment of the disclosed occupancy detection system; and

FIGS. 5A and 5B illustrate an exemplary logic flow according to a method of operating the disclosed occupancy detection system.

### DETAILED DESCRIPTION

The disclosed system and method utilize one or more gas detection sensors to detect human occupancy of a space and to adjust lighting and/or other electrical loads servicing the space. Gas detection technology can be used by itself, or it can be used in combination with other sensing technologies such as passive infrared (PIR), ultrasonic, microwave, acoustic, video or other occupant sensing techniques. In one non-limiting exemplary embodiment, the system monitors CO₂ concentration of a space, where the CO₂ concentration is representative of the presence or absence of an occupant.

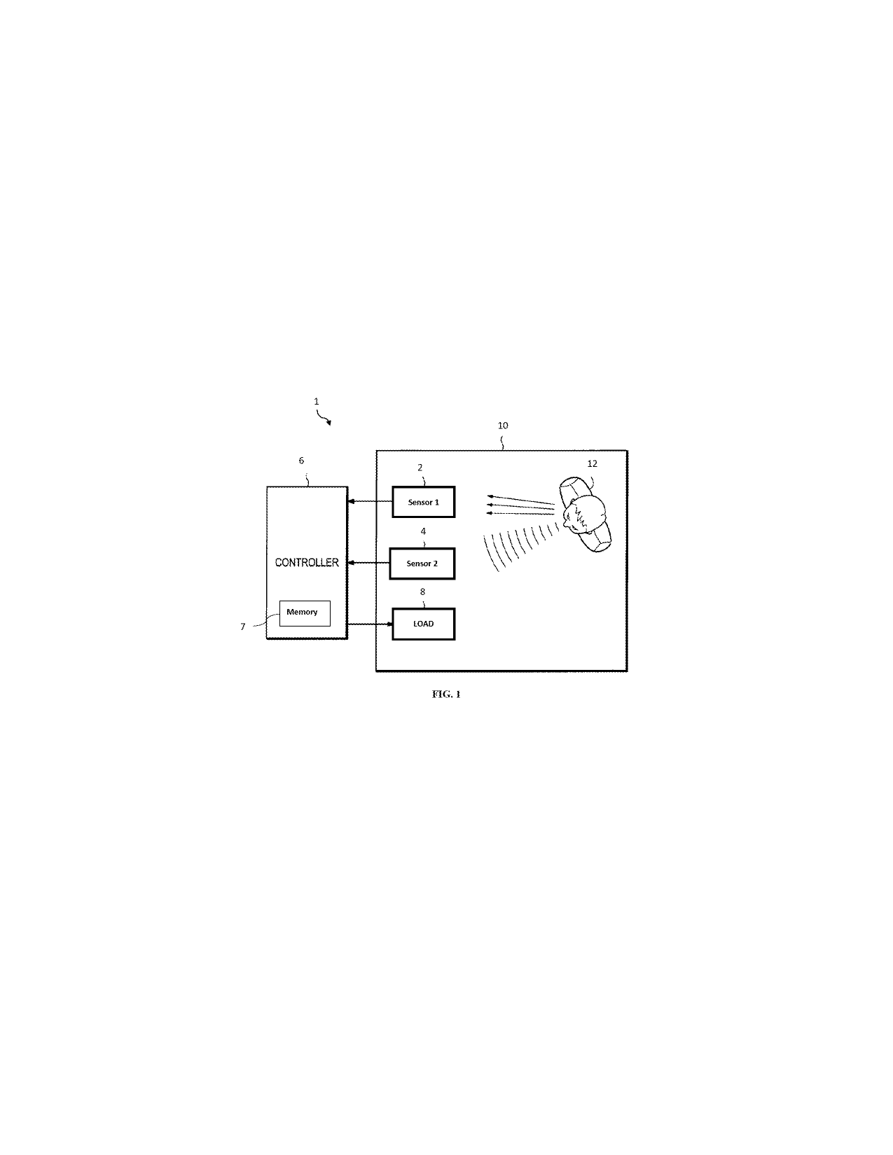

Turning now to FIG. 1, an exemplary embodiment of an occupancy sensing system 1 is shown. The embodiment of FIG. 1 includes a gas sensor 2 and a secondary sensor 4 coupled to a controller 6 so that the sensors can send signals to the controller. The controller 6 may be operable to control an electrical load 8 for a monitored space 10 in response to an occupancy determination based on signals received by the gas sensor 2 and/or the secondary 4 which are arranged to sense one or more occupants 12 within the space. The controller 6 may have access to non-volatile memory 7 to store information relating to the gas sensor 2 and secondary sensor 4. For example, the memory 7 may contain processed or unprocessed signal storage logs relating to the sensors 2, 4.

In one embodiment, the gas sensor 2 is a CO₂ sensor, while the second sensor is a passive infrared (PIR) sensor. It will be appreciated that the sensing system 1 is not limited to one gas sensor 2 and one secondary sensor 4, and thus some embodiments of the system include a gas sensor 2 and two secondary sensors 4.

The gas sensor 2 may be configured to sense any of a variety of gases that are indicative of the presence of a person, including CO₂, CO, HC. In addition, the gas sensor 2 can include any appropriate technology, such as non-dispersive infrared (NDIR) gas sensors, chemical gas sensor, or other type. Further, more than one gas sensing element can be used to make up the gas sensor 2. In exemplary embodiments, the gas sensor 2 is a thermopile or pyroelectric detector. Such sensors are sold by PerkinElmer, Inc. 940 Winter Street, Waltham, Mass. 02451. Gas sensing ranges may be also be selected to suit the particular application. For example, if the sensor 2 is a CO₂ sensor, a sensing range of about 0 parts per million (ppm) to 10,000 ppm may be used. Alternatively, if the sensor 2 is a CO sensor, a sensing range of about 10 ppm to 1,000 ppm may be used.

The secondary sensor or sensors 4 may be any of a variety of sensing types that, along with the gas sensor 2, can be used to detect the presence of a person in a space. In one exemplary embodiment, the secondary sensor 4 is a PIR sensor. It will be appreciated, however, that the secondary sensor 4 is not limited to PIR technology, and can instead be a passive or an active ultrasound sensor, an acoustic sensor, a video sensor, a microwave sensor, or any other sensor using technology that can detect an occupancy characteristic of the space (or a combination thereof).

In some embodiments the gas sensor 2 may be a first type of gas sensor, while the secondary sensor 4 may be a second type of gas sensor. For example, the first gas sensor may be configured to sense CO₂ concentration, while the second sensor may be configured to sense CO concentration.

The electrical load 8 may include any of a variety of incandescent, fluorescent and LED lighting loads, or a combination thereof, that may act on the space in response to the occupancy condition of the space.

The controller 6 may be implemented in hardware, software or any combination thereof. The complexity and functionality of the controller 6 may depend on the relative complexity and functionality of the other components of the system. For example, in a system with highly integrated sensors 2, 4, the controller 6 may only include relatively simple logic to control the load 8 in response to binary signals from the sensors. In other embodiments with relatively low level sensors, the controller may include extensive hardware and/or software to process the signals from the sensors.

The controller 6 may also include various types of hardware and/or software to control the load 8. For example, in some embodiments, the controller may include complete load switching circuitry such as relays, transistors, thyristors (or a combination thereof), etc., to provide on/off, dimming, or other forms of load control. In other embodiments, the controller may only provide a simple digital or analog output control signal to enable other apparatus to control power to the load. The controller may include one or more microprocessors or microcontrollers, discrete logic, analog circuitry, or any other suitable apparatus and/or software to implement any of the automatic sensing and/or control schemes according to the principles of the present disclosure.

The connections between the controller 6, the gas sensor 2, the secondary sensor 4 and/or the load 8 may be in any suitable form. Hardwired connections may include screw or spring terminals, pigtail leads, printed circuit (PC) board traces, fiber-optic cable, etc. Wireless connections may include any signaling media such as radio frequency (RF), infrared (IR), optical, etc.

The components shown in FIG. 1 may be arranged in any physical relation to the space 10 and to each other. Any or all of the components may be located in, near, or remote from the space. For example, electrical lighting loads may typically be located in or just above the space. The controller 6, gas sensor 2 and secondary sensor 4 may be arranged in any combination of common or separate locations and in common or separate enclosures, if any. For example, in one embodiment, the controller, gas sensor 2 and secondary sensor 4 may be located in a common wall switch enclosure that includes power control circuitry for controlling the load. In another embodiment, the gas and secondary sensors 2, 4 may be located in one or more separate enclosures that are mounted remotely from the controller. In yet another embodiment, the controller, gas sensor, and secondary sensor may be located in a ceiling mount or wall/corner mount enclosure that sends low-voltage control signals to a relay cabinet or other apparatus for controlling the power to the load.

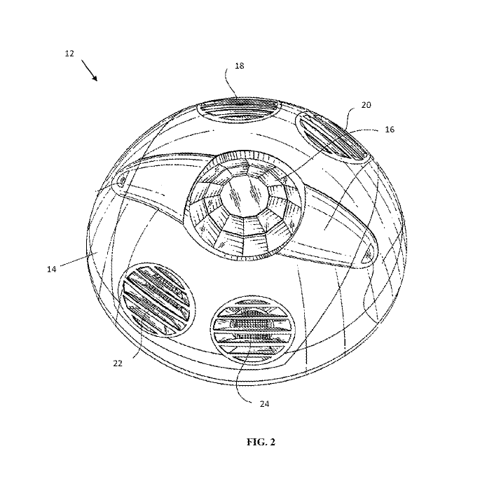

FIG. 2 illustrates an embodiment of an occupancy sensor 12 configured as a ceiling mounted unit in which a plurality of individual sensors are included in a single housing. Occupancy sensor 12 may include a housing 14 having a lens assembly 16 and a plurality of vents or grates, 18, 20, 22, 24 for providing access to sensors positioned beneath the grates. Although a hemispherical shaped housing is shown, those skilled in the art will recognize that the physical variations in shape of the housing can be changed while retaining the function described above. For example, the sensor housing may be square, box shaped or elliptical. The controller (not shown) may be positioned within the housing 14, or it may be positioned remote from the housing.

In the illustrated embodiment, the occupancy sensor 12 employs three different types of sensors. Thus, one or more gas sensors 2 can be positioned within the housing 14 adjacent to at least one of the vents 18-24, a PIR sensor may be positioned within the housing 14 adjacent to the lens 16, and an ultrasonic sensor can be positioned within the housing 14 adjacent at least one of the vents 18-24. In operation, the sensors may sense motion using the PIR sensor and ultrasonic sensor and may sense a gas concentration using the gas sensor. Signals from one or more of the sensors may be transmitted to the controller by a wired connection or a wireless connection. A wireless connection may be advantageous where the controller is positioned remote from the housing. Although the illustrated embodiment is described as having two secondary sensors comprising PIR and ultrasonic technologies, it will be appreciated that the secondary sensors of this embodiment could employ any of a variety of other sensing technologies (as previously described). They could also be secondary gas sensors configured to sense a gas that is the same as, or different from, that of the primary gas sensor 2.

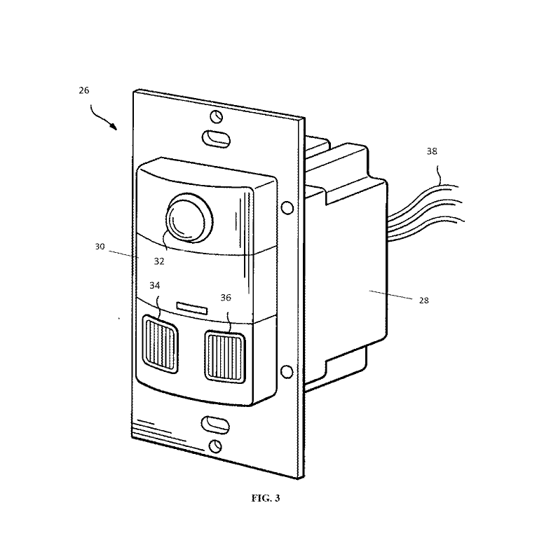

FIG. 3 illustrates another embodiment of an occupancy sensor 26 configured as a wall-switch for mounting in a standard electrical wall box. The occupancy sensor 26 includes a housing 28 having a front plate 30 containing a lens 32, and first and second vents 34, 36. The gas sensor 2 may be positioned adjacent one of the first and second vents 34, 36, while a secondary PIR sensor 4 can be positioned adjacent the lens 32, and a secondary ultrasonic sensor 4 can be positioned adjacent one of the first and second vents 32, 34. In this embodiment, the controller is positioned within the housing and is operable to energize or de-energize lighting or other electrical loads for the monitored space in the room in response to signals received from the sensors 2, 4. Connections to a building power supply are through pigtail wire leads 38 or terminal blocks, which include hot, neutral, switched and ground connections.

As noted, the controller may be included in the housing 28. Alternatively, the controller may be positioned remotely from the housing 28 and sensors 2, 4 and may take input from more than one occupancy sensor 26 associated with one or more rooms. In one embodiment, the controller can be coupled to a building automation server or automation system for providing occupancy information to a central location.

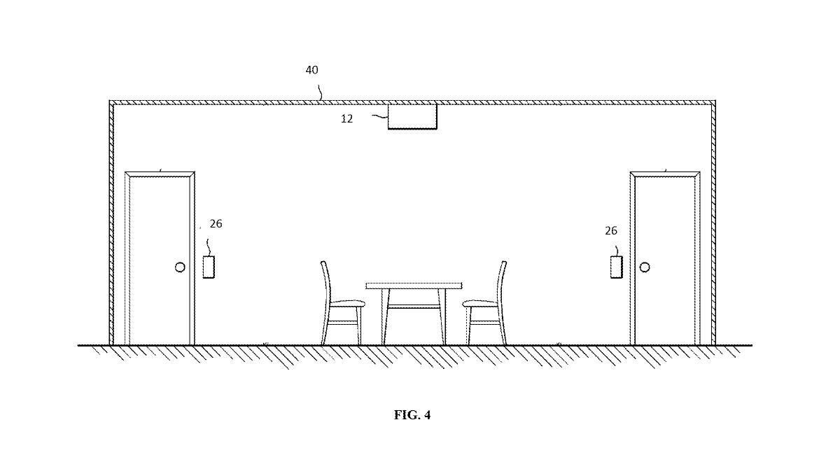

FIG. 4 illustrates an embodiment of an occupancy sensing system in which a plurality of occupancy sensors 12, 26 are installed for monitoring a room 40. In this embodiment the room 40 can be a meeting room. A first occupancy sensor 12 (FIG. 2) can be installed on a ceiling of the room, while second and third occupancy sensors 26 (FIG. 3) can mounted as wall switch units. In one embodiment, all of the occupancy sensors 12, 26 can provide signals from their respective individual sensors (e.g., gas sensors, PIR sensors, ultrasonic sensors) to a central processor which can combine the information to make a determination regarding an occupancy state of the room. In some cases each of the occupancy sensors 12, 26 may also include their own local processors or circuitry for performing pre-processing and/or signal conditioning prior to sending signals to the central processor.

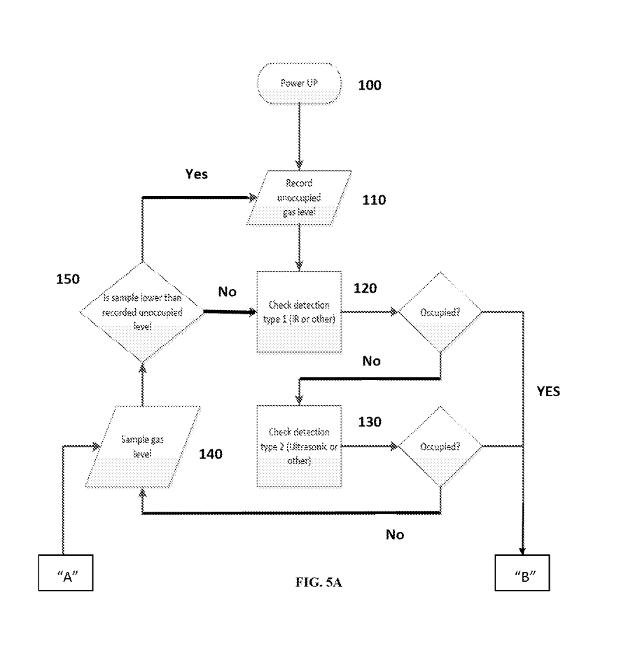

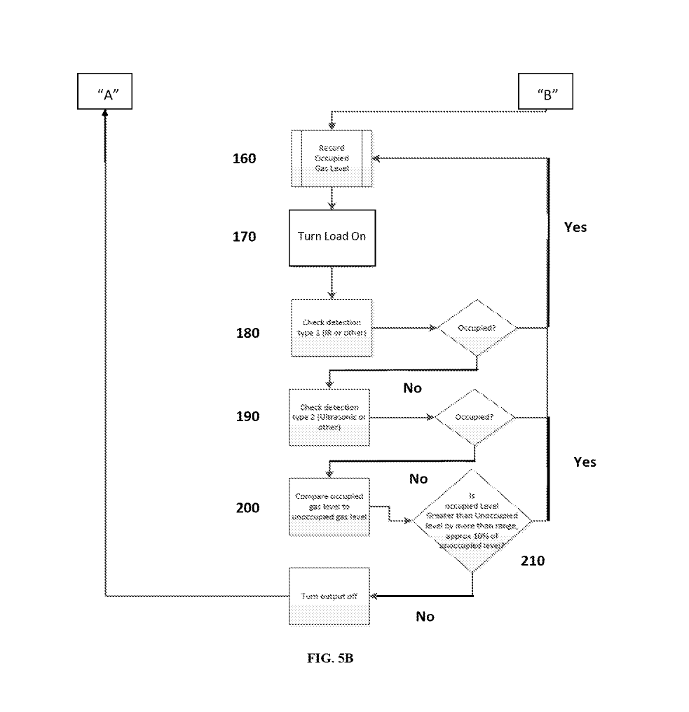

Referring now to FIGS. 5A and 5B, a method for operating the disclosed system 1 will be described in greater detail. In general, the system 1 has two states, the first termed the “unoccupied” state, and the second termed the “occupied” state. During the unoccupied state, the system 1 runs a constant (or periodic/recurring) loop looking for detection by non gas-sensing technologies. During each loop the system samples gas level and updates an unoccupied recorded level with a lowest detected gas level detected while the system is in the unoccupied state. Once occupancy is detected by one of non-gas-sensing technologies, an “occupied” loop begins to run. As part of the “occupied” loop, sensed gas levels are recorded. A check of the non-gas sensors is also undertaken. If both non-gas sensors report unoccupied, the system compares occupied gas level to unoccupied gas levels. If the occupied gas level is within a predetermined amount (e.g., 10%) of the unoccupied level, then the system 1 classifies the space as being unoccupied. If the occupied gas level is not within the predetermined amount, then the system maintains the space classified as occupied, and the “occupied” loop is rerun.

In some embodiments, a setup or test routine can be performed to establish baseline CO₂ levels for a particular space. Alternatively, baseline levels can be established for any other suitable gas or combination of gases. For example, one or more gas sensors 2 can be used to measure CO₂ levels over time to develop a baseline profile of CO₂ levels for the space. This baseline information may later be used to account for changes in CO₂ levels caused by factors other than human occupancy of the space. For example, building heating, ventilation and air conditioning (HVAC) systems can affect CO₂ levels in a space due to the flushing of air that occurs as part of normal indoor climate controls. Since the CO₂ concentration will change at a faster rate due to such air flushing than it would due to the presence or absence of an occupant, the baseline information can include gas concentration rate of change data for the space. Thus, if the system determines that CO₂ levels are decreasing faster than a certain predetermined rate, the system may conclude that the building's HVAC system was briefly operated in the room and that the room remains occupied despite the rapidly falling CO₂ levels.

Once a baseline CO₂ level is established for a particular space, if further monitoring (using one or more gas sensors 2) determines that levels have risen above the baseline “unoccupied” levels for that space, a signal can be generated to indicate that the room is occupied. This signal can be used to turn on lighting controls for the space (or to maintain the lighting in the “on” condition) so that the space is lit to a predetermined level. If, thereafter, the monitored CO₂ level returns to the baseline levels (again, assuming the change was not caused solely by operation of the HVAC system in the space), the space would be determined “unoccupied” and a signal can be generated to indicate the room is unoccupied. This signal may be used to return the lighting controls to a predetermined unoccupied level. In one exemplary embodiment, the “on” or “occupied” condition of the lighting would be a fully lit configuration, wherein the “unoccupied” condition of the lighting would be a fully off configuration. It will be appreciated, however, that other configurations are also possible. For example, in the “on” or “occupied” condition, the lighting for the room could be set to ensure that fewer than all of the lights in the room are fully lit. Likewise, in the “unoccupied” condition, the lighting in the room could be set that only a single light in the room is lit at a less than full intensity (i.e., dimmed) condition. Alternatively, the system may be used to control/configure any suitable type of device in any suitable manner. Other permutations are contemplated, and will be understood by one of ordinary skill in the art.

In addition, since gas levels can change very gradually, in some embodiments gas sensing arrangement may be combined with a secondary detection mechanism, for example, a passive infrared (PIR) sensor and/or an ultrasonic sensor. In one example, a PIR sensor may be used to make an initial occupancy determination as a person is sensed entering the room. The PIR sensor could generate an “occupied” signal to turn the room lights to a predetermined level. As the occupant remains in the room, the CO₂ levels would naturally rise above a baseline “unoccupied” level, whereupon the gas sensor may generate a signal representative of a final “occupied” signal to ensure the room lights are maintained at the “occupied” level even if the PIR sensor no longer senses the occupant in the room. For example, as the occupant sleeps or performs some task such as reading that involves little or no motion, the PIR sensor may generate an “unoccupied” signal, since a lack of motion typically indicates (with a PIR sensor) that the room is no longer occupied. Based on the signal generated by the gas sensor, however, the room, would be maintained in the “occupied” state because the CO₂ levels remain above the baseline levels for the room, thus indicating that the person is still in the room. When the occupant leaves the room, the PIR sensor may normally be arranged to generate an “unoccupied” signal that would immediately, or within predetermined time delay, turn “off” the lights. The system may, however, delay configuring the lighting in the “unoccupied” configuration until the CO₂ levels gradually return to the “unoccupied” baseline level. Thus, by incorporating a gas sensor into combination with a more traditional occupant sensing technology to increase reliability of the occupancy determination.

Referring again to FIGS. 5A and 5B, at step 100, the occupancy sensor 12, 26 is powered up. At step 110, unoccupied gas levels for the space are sampled using the gas sensor 2 and recorded in memory. At step 120, a determination is made as to whether the first of a pair of secondary sensors 4 indicates that the space is occupied. If the first of the pair of secondary sensors 4 indicates that the space is not occupied, then at step 130 determination is made as to whether the second of a pair of secondary sensors 4 indicates that the spaces is occupied. If the second of the pair of secondary sensors 4 indicates that the space is not occupied, then at step 140 the gas level is sampled using the gas sensor 2. At step 150 a determination is made as to whether the sampled gas concentration is lower than the unoccupied gas level recorded at step 110. If the sampled gas concentration is lower than the unoccupied gas level recorded at step 110, then the method returns to step 110 and the sampled gas concentration is recorded in memory. If, however, the sample gas concentration is higher than the unoccupied gas level recorded at step 110, then the method returns to step 120 where a determination is made as to whether the first of a pair of secondary sensors 4 indicates that the space is occupied. The process continues as before.

If, however, at either step 120 or step 130 the first or second of the pair of secondary sensors 4 indicates that the space is occupied, then the space is deemed to be occupied, and at step 160 gas level sampled using the gas sensor 2 is recorded in memory. At step 170 the load 8 is turned on, and at step 180 a determination is made as to whether the first of a pair of secondary sensors 4 indicates that the space is occupied. If the first of the pair of secondary sensors 4 indicates that the space is occupied, then the process returns to step 160 where the gas level is sampled and recorded. If, however, the first of the pair of secondary sensors 4 indicates that the space is not occupied, then at step 190 a determination is made as to whether the second of a pair of secondary sensors 4 indicates that the spaces is occupied. If the second of the pair of secondary sensors 4 indicates that the space is occupied, then the process returns to step 160 where the gas level is sampled and recorded. If, however, the second of the pair of secondary sensors 4 indicates that the space is not occupied, then at step 200 the occupied gas level recorded at step 160 is compared to the unoccupied gas level recorded at step 110. If the occupied gas level is greater than the unoccupied gas level by more than 10% of the unoccupied gas level, then the occupied gas level is recorded in memory at step 160, and the process continues. If, however, the occupied gas level is not greater than the unoccupied gas level by more than 10% of the unoccupied gas level, then the process returns to step 140 where the gas level is again sampled. The process continues on from there in a manner previously described.

Although portions of the description proceeded in relation to use of the disclosed system and method in a hotel room, it will be appreciated that such applications are not limiting. The disclosed system and method can be used any of a variety of rooms and spaces, including cafeterias, computer rooms, day care centers, workspaces, restrooms, offices with cubicles, classrooms, conference rooms, stairwells, executive, open and private offices.

Some embodiments of the disclosed device may be implemented, for example, using a storage medium, a computer-readable medium or an article of manufacture which may store an instruction or a set of instructions that, if executed by a machine, may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A method for determining occupancy/vacancy status of a space, comprising:
monitoring a concentration of a first gas in a space using a first gas sensor;
determining a status of the space based on the concentration of the first gas; and
controlling an electrical load associated with the space based on the determined status.

2. The method of claim 1, further comprising monitoring the space using a second sensor, and determining the vacancy status of the space based on the concentration of the first gas and information from the second sensor.

3. The method of claim 1, wherein monitoring a concentration of a first gas comprises sampling gas concentrations at first and second times, and wherein determining a vacancy status further comprises comparing the sampled gas concentrations at the first and second times.

4. The method of claim 3, wherein when the gas concentration at the first time is less than the gas concentration at the second time the gas sensor provides a signal representative of a vacancy condition of the space.

5. The method of claim 4, wherein when the gas concentration at the second time is within a predetermined range with respect to the gas concentration at the first time the gas sensor provides a signal representative of a vacant condition of the space.

6. The method of claim 2, wherein the first sensor is a carbon dioxide sensor and the second sensor is a passive infrared sensor.

7. The method of claim 2, further comprising monitoring the space using a third sensor; wherein determining a vacancy status of the space is based on the concentration of the first gas and information from the second sensor and the third sensor.

8. The method of claim 7, wherein when the vacancy status of the space is determined at a third time to be occupied based on information from the second and third sensors, the method further comprises recording an occupied gas concentration.

9. The method of claim 3, wherein when the vacancy status of the space is determined at a fourth time to be vacant based on information from the second and third sensors, the method further comprises comparing the occupied gas concentration to a baseline gas concentration, the baseline gas concentration associated with a vacant state of the space.

10. The method of claim 9, wherein when the difference between the occupied gas concentration and the vacant gas concentration is within a predetermined range, the space is determined to be vacant.

11. The method of claim 10, wherein the predetermined range is about 105% to 115% of the unoccupied gas concentration.

12. The method of claim 10, wherein the predetermined range is about 110% of the unoccupied gas concentration.

13. A system for determining a vacancy status of a space, comprising:
a first sensor for sensing a gas concentration of a space;
a second sensor for monitoring the space;
a controller coupled to the first and second sensors for receiving signals from the first and second sensors and for determining a vacancy status of the space based on said received signals, the controller configured to control an electrical load for the space in response to the determined vacancy status.

14. The system of claim 13, wherein the first sensor is a carbon dioxide sensor and the second sensor is a passive infrared sensor or an ultrasonic sensor.

15. The system of claim 13, wherein the first and second sensors are gas sensors, the first sensor configured to sense a concentration of a first gas, the second sensor configured to sense a concentration of a second gas.

16. The system of claim 13, further comprising a third sensor for monitoring the space, the third sensor coupled to the controller for sending signals to the controller representative of a vacancy status of the space.

17. The system of claim 16, wherein the second and third sensors are selected from the list consisting of a passive infrared sensor, and ultrasonic sensor, a gas sensor, a microwave sensor, an audio sensor, and a video sensor.

18. The system of claim 13, wherein the controller is located remotely from the first and second sensors.

19. The system of claim 13, further comprising a non-volatile memory associated with the controller for storing a plurality of gas concentration values received from the first sensor.

20. The system of claim 13, further comprising a third sensor for monitoring the space, wherein the controller is configured to receive signals from the third sensor and to determine a vacancy status of the space based on the received signals from the first, second and third sensors.

21. A method for determining vacancy status of a space, comprising:
determining a concentration of a first gas in a space using a first gas sensor;
monitoring the space for the presence of an occupant using a second sensor;
determining a vacancy status of the space based on the concentration of the first gas and occupant presence information from the second sensor; and
controlling a lighting load associated with the space based on the determined vacancy status.

22. The method of claim 21, wherein monitoring a concentration of a first gas comprises sampling gas concentrations at first and second times, and wherein determining a vacancy status further comprises determining a rate of change of the sampled gas concentrations between the first and second times.

23. The method of claim 22, wherein when the rate of change of the sampled concentrations between the first and second times exceeds a predetermined value, the space is determined to be occupied.

24. The method of claim 21, wherein the first sensor is a carbon dioxide sensor and the second sensor is a passive infrared sensor.
